(19) United States
(12) Patent Application Publication
(10) Pub. No.: US 2026/0031634 A1
(43) Pub. Date: Jan. 29, 2026

(54) Circuit Device And Electronic Apparatus

(71) Applicant: SEIKO EPSON CORPORATION, Tokyo (JP)

(72) Inventor: Kinya MATSUDA, Matsumoto (JP)

(21) Appl. No.: 19/282,504

(22) Filed: Jul. 28, 2025

(30) Foreign Application Priority Data
Jul. 29, 2024 (JP) 2024-121851

(51) Int. Cl. H02J 7/00; H02J 50/10

(52) U.S. Cl. CPC H02J 7/00306; H02J 7/0047; H02J 7/007182; H02J 50/10

(57) ABSTRACT

A circuit device includes a charging circuit configured to charge a battery and a control circuit configured to control the charging circuit. The battery is provided with a protection circuit of the battery that comes into a shutdown state when the battery is in an over-discharge state. The control circuit causes the charging circuit to increase the charging current from an initial current value larger than zero to start constant-current charging of the battery when the shutdown state of the protection circuit is released.

The present application is based on, and claims priority from JP Application Serial Number 2024-121851, filed Jul. 29, 2024, the disclosure of which is hereby incorporated by reference herein in its entirety.

### BACKGROUND

### 1. Technical Field

The present disclosure relates to a circuit device, an electronic apparatus, and so on.

### 2. Related Art

In an electronic apparatus capable of charging a battery, a protection circuit called a protection circuit module (PCM) may be provided to the battery side in some cases. The protection circuit prevents over-discharge and overcharge of the battery. Further, JP-A-2012-60757 discloses a charge control device that prevents deterioration of a battery due to a rapid current at the start of charging. This charge control device performs charge control of setting a target current value in constant-current charging, and increasing a charging current to a target current value at the start of charging.

JP-A-2012-60757 is an example of the related art.

It has been found out that, in such an electronic apparatus provided with the protection circuit as described above, when the charging control of increasing the charging current to the target current value is performed after a shutdown state of the protection circuit is released, a problem that the protection circuit makes the transition to the shutdown state once again arises. When such a situation occurs, the shutdown state of the protection circuit cannot be released, and a problem that the battery cannot appropriately be charged arises.

### SUMMARY

An aspect of the present disclosure relates to a circuit device including a charging circuit configured to charge a battery, and a control circuit configured to control the charging circuit, wherein the battery is provided with a protection circuit of the battery that comes into a shutdown state when the battery is in an over-discharge state, and the control circuit causes the charging circuit to increase a charging current from an initial current value larger than zero to start constant-current charging of the battery when the shutdown state of the protection circuit is released.

Another aspect of the present disclosure relates to an electronic apparatus including the circuit device described above, the battery, and the protection circuit.

### BRIEF DESCRIPTION OF THE DRAWINGS

FIG. 1 illustrates a configuration example of a circuit device and an electronic apparatus according to the present embodiment.

FIG. 2 illustrates a detailed configuration example of the circuit device and the electronic apparatus.

FIG. 3 illustrates a detailed configuration example of a circuit device and an electronic apparatus when performing contactless power transmission.

FIG. 4 shows a configuration example of a charging circuit.

FIG. 5 is a diagram illustrating CCCV charging.

FIG. 6 is a diagram illustrating step-up current charging.

FIG. 7 is a diagram illustrating a method according to the embodiment.

FIG. 8 is a diagram illustrating a method according to the embodiment.

FIG. 9 is a diagram illustrating storage of an initial current value, a step-up current value, and a step-up time into a storage unit.

FIG. 10 is a flowchart illustrating an operation of the embodiment.

### DESCRIPTION OF EMBODIMENTS

The present embodiment will hereinafter be described. Note that the present embodiment described below does not unreasonably limit the description content of the appended claims. Further, all the configurations described in the embodiment are not necessarily essential elements.

### 1. Circuit Device and Electronic Apparatus

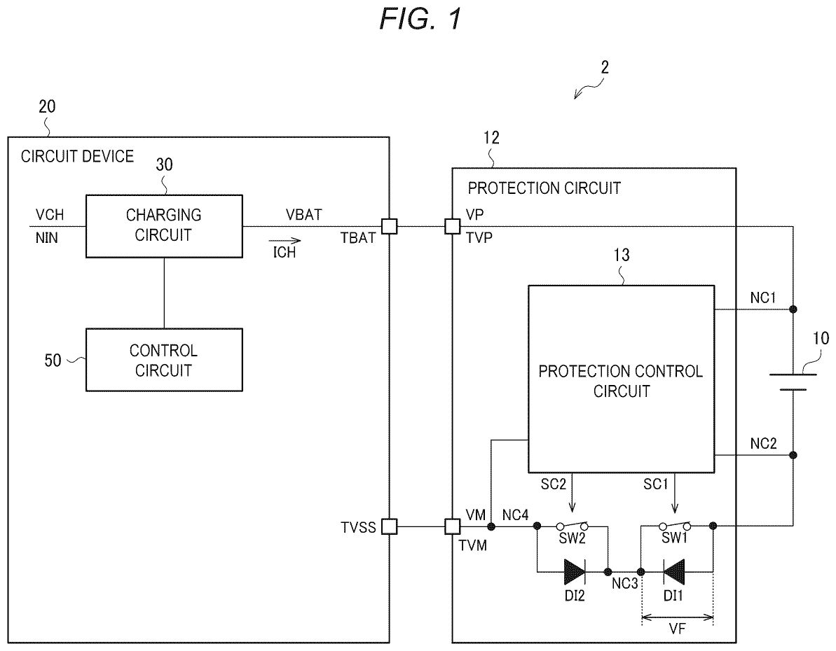

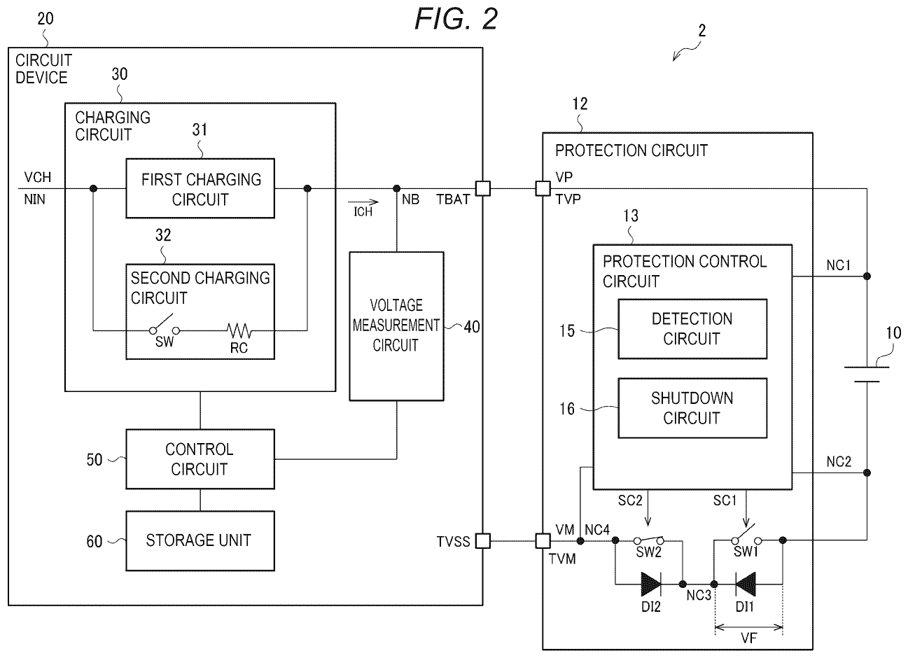

FIG. 1 illustrates a configuration example of a circuit device 20 and an electronic apparatus 2 in the present embodiment. The circuit device 20 includes a charging circuit 30 and a control circuit 50. Further, the electronic apparatus 2 includes the circuit device 20, a battery 10, and a protection circuit 12. Note that the circuit device 20, the electronic apparatus 2, and the protection circuit 12 are not limited to the configuration in FIG. 2, and various modified implementations such as omission of some of the elements thereof or addition of other elements thereto can be made.

The electronic apparatus 2 is a hearable device such as a hearing aid or an earphone for audio listening, or a wearable device. The earphone is, for example, what is called a wireless earphone. Note that as the electronic apparatus 2, various apparatuses such as a head-mounted display, a portable communication terminal such as a smartphone or a mobile phone, a wristwatch, a biological information measurement apparatus, a shaver, an electric toothbrush, a wrist computer, a handy terminal, or an in-vehicle apparatus of an automobile can be assumed.

The circuit device 20 operates as, for example, a charging device that charges the battery 10. The circuit device 20 can be realized by, for example, an integrated circuit device called an IC. The battery 10 which is a charging target is, for example, a secondary battery, such as a lithium-ion secondary battery, a nickel-metal hydride battery, or a nickel-cadmium battery. Further, the battery 10 may be what is realized by a super capacitor or the like. The battery 10 is coupled to terminals TBAT, TVSS of the circuit device 20 via the protection circuit 12. The terminals TBAT, TVSS are, for example, pads or external connection terminals of a package of the circuit device 20 which is an IC. For example, in a pad area, a metal layer is exposed from a passivation film that is an insulating layer, and the metal layer thus exposed constitutes the pad that is the terminal of the circuit device 20. Note that the coupling in the present embodiment is electrical coupling. The electrical coupling means coupling in which an electrical signal can be transmitted, and is coupling in which information can be transmitted with an electrical signal. The electrical coupling may be coupling through a passive element and the like.

The protection circuit 12 is a circuit that protects the battery 10. For example, the protection circuit 12 is a circuit that detects an over-discharge state or an overcharge state of the battery 10 to protect the battery 10 from the over-discharge or the overcharge. The protection circuit 12 is also called, for example, a protection circuit module (PCM). For example, the battery 10 and the protection circuit 12 are incorporated in a battery pack. A terminal TVP is, for example, a positive external connection terminal of the battery pack, and is coupled to a positive terminal of the battery 10. A terminal TVM is, for example, a negative external connection terminal of the battery pack, and is coupled to a negative terminal of the battery 10. The terminal TVM is coupled to, for example, a terminal TVSS of VSS of the circuit device 20.

The protection circuit 12 (protection circuit module) includes a protection control circuit 13 and switches SW1, SW2. The protection control circuit 13 can be realized by, for example, an IC for battery protection. The switches SW1, SW2 can be realized by, for example, N-type MOS transistors. Further, the switches SW1, SW2 are on-off controlled by control signals SC1, SC2 from the protection control circuit 13.

The switches SW1, SW2 are disposed in series between a node NC2 of the negative terminal of the battery 10 and a node NC4 of the terminal TVM. Note that a node NC1 is a node of the positive terminal of the battery 10. The switch SW1 is a switch for over-discharge, and the switch SW2 is a switch for overcharge. For example, in FIG. 1, the switch SW1 for over-discharge is disposed between the node NC2 of the negative terminal of the battery 10 and a node NC3 which is a connection node of the switches SW1, SW2. Further, the switch SW2 for overcharge is disposed between the node NC3 and the node NC4 of the terminal TVM.

Specifically, in the transistor constituting the switch SW1, the source is coupled to the node NC2 of the negative terminal of the battery 10, the drain is coupled to the node NC3, and the control signal SC1 from the protection control circuit 13 is input to the gate. Further, in the transistor constituting the switch SW2, the source is coupled to the node NC4 of the terminal TVM, the drain is coupled to the node NC3, and the control signal SC2 from the protection control circuit 13 is input to the gate. Further, diodes DI1, DI2 are realized by, for example, body diodes of the transistors constituting the switches SW1, SW2. For example, by the source and the back gate of the transistor constituting the switch SW1 being coupled at the node NC2, the diode DI1 forward direction of which is a direction from the node NC2 toward the node NC3 is realized. Further, by the source and the back gate of the transistor constituting the switch SW2 being coupled at the node NC4, the diode DI2 forward direction of which is a direction from the node NC4 toward the node NC3 is realized. Note that a modification in which the diodes DI1, DI2 are provided separately from the switches SW1, SW2 is also possible.

For example, in a normal state, the switches SW1, SW2 are turned on. Then, when the protection control circuit 13 detects an over-discharge state, the switch SW1 is turned off by the control signal SC1. On this occasion, the switch SW2 remains in the on state. Further, the diode DI1 is a diode forward direction of which is a direction from the node NC2 toward the node NC3. Therefore, a discharging current, which is a current in the direction from the node NC3 toward the node NC2, stops flowing when the switch SW1 is turned off, and thus a situation in which the battery 10 is further discharged from the over-discharge state is prevented. Further, even when the over-discharge state is detected and the switch SW1 is turned off, the charging current, which is the current in the direction from the node NC2 toward the node NC3, can flow through the diode DI1. Accordingly, it becomes possible to charge the battery 10 in the over-discharge state. Note that VF is a forward voltage of the diode.

Further, when the protection control circuit 13 detects the overcharge state, the switch SW2 is turned off by the control signal SC2. On this occasion, the switch SW1 remains in the on state. Further, the diode DI2 for overcharge is a diode forward direction of which is a direction from the node NC4 toward the node NC3. Therefore, the charging current, which is a current in the direction from the node NC3 toward the node NC4, stops flowing when the switch SW2 is turned off, and thus a situation in which the battery 10 is further charged from the overcharge state is prevented. Further, even when the overcharge state is detected and the switch SW2 is turned off, the discharging current, which is the current in the direction from the node NC4 toward the node NC3, can flow through the diode DI2. Accordingly, it becomes possible to discharge the battery 10 in the overcharge state.

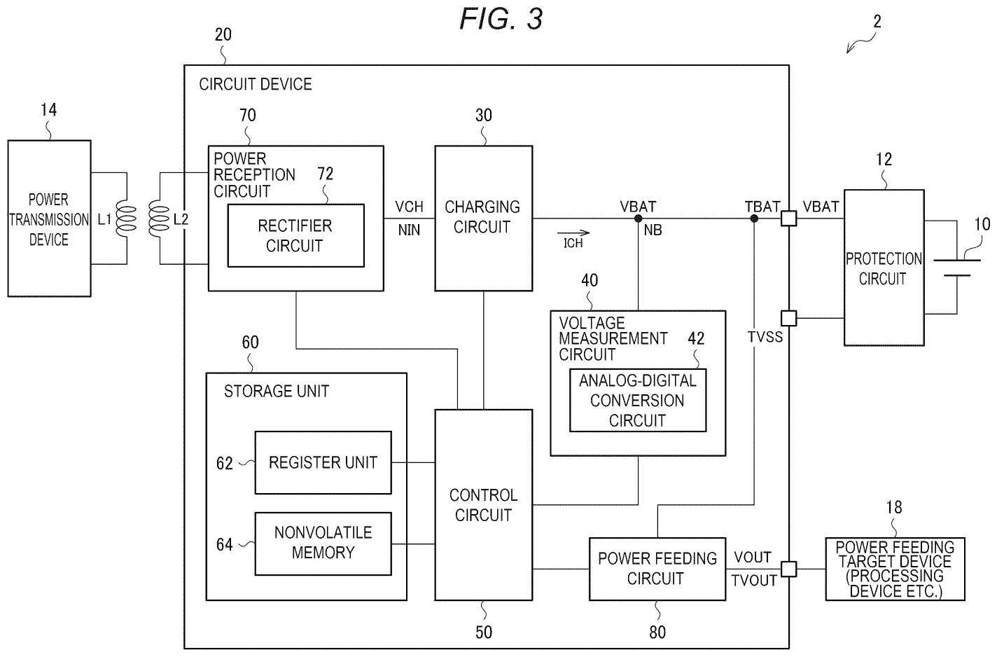

The charging circuit 30 charges the battery 10. For example, the charging circuit 30 charges the battery 10 with the received power by a charging voltage VCH supplied to a node NIN. For example, the charging circuit 30 generates and supplies a charging current ICH based on the charging voltage VCH to thereby charge the battery 10. The charging voltage VCH is a power supply voltage for charging. Specifically, the charging circuit 30 charges the battery 10 by constant-current charging or CCCV charging. In the CCCV charging, constant-current charging, which is CC charging of the battery 10, is first performed, and then switching to constant-voltage charging, which is CV charging, is made to further charge the battery 10. For example, the battery 10 is charged by constant-current charging, and when a battery voltage VBAT reaches a predetermined voltage, the constant-current charging is switched to the constant-voltage charging. Note that the power received due to the charging voltage VCH may be power received using contactless power transmission as illustrated in FIG. 3 described later, or may be power received using contacted power transmission via wire. That is, the charging by the charging circuit 30 may be wireless charging or contact-type charging. Further, the charging voltage VCH is, for example, 5 V to 4 V, and the battery voltage VBAT is, for example, 4.3 V to 3.6 V.

The control circuit 50 performs various types of control processing and arithmetic processing. For example, the control circuit 50 controls the charging circuit 30. The control circuit 50 can be realized by, for example, an application specific integrated circuit (ASIC) using automatic layout and wiring such as a gate array, but may be realized by a processor such as a digital signal processor (DSP), a central processing unit (CPU), or a microcontroller.

Further, the battery 10 is provided with the protection circuit 12 that protects the battery 10. The protection circuit 12 comes into a shutdown state when the battery 10 is in the over-discharge state. For example, the protection circuit 12 is attached so as to be coupled to the battery 10. Specifically, the protection circuit 12 is incorporated in the battery pack that houses the battery 10 and is coupled to the battery 10. Further, when the over-discharge state of the battery 10 is detected, the protection circuit 12 turns off the switch SW1 as described above so that the battery 10 is not discharged, and comes into the shutdown state. Then, when the protection circuit 12 comes into the shutdown state, a voltage difference between a voltage VP of the terminal TVP and a voltage VM of the terminal TVM becomes 0 V. In this way, by establishing the shutdown state in which a potential difference between the voltage VP and the voltage VM becomes 0 V, a consumption current of the IC of the protection circuit 12 becomes 0, and it becomes possible to prevent the consumption current from flowing through the protection circuit 12 when the battery 10 is in the over-discharge state.

Further, when such a shutdown state of the protection circuit 12 is released, the control circuit 50 causes the charging circuit 30 to increase the charging current from an initial current value larger than zero to start the constant-current charging of the battery 10. For example, in the present embodiment, the constant-current charging of the battery 10 is performed after the charging current is increased to the target current value. However, when it is attempted to perform the constant-current charging with the charging current increased from the initial current value of zero when the shutdown state of the protection circuit 12 is released, a period in which no current flows occurs due to the initial current value of zero, and a problem that the protection circuit 12 returns to the shutdown state again arises.

Therefore, in the present embodiment, when the shutdown state of the protection circuit 12 is released, the control circuit 50 causes the charging circuit 30 to supply the charging current having the initial current value larger than zero to increase the charging current from the initial current value, and starts the constant-current charging. In this way, when the shutdown state is released, an initial current value larger than zero flows, so that a period in which no current flows does not occur. Accordingly, it is possible to prevent a situation in which the protection circuit 12 in which the shutdown state is released returns to the shutdown state again, and it becomes possible to start appropriate constant-current charging of the battery 10.

FIG. 2 shows a detailed configuration example of the circuit device 20 and the electronic apparatus 2 according to the present embodiment. In FIG. 2, the circuit device 20 is further provided with a voltage measurement circuit 40 and a storage unit 60 in addition to the charging circuit 30 and the control circuit 50. Note that the circuit device 20 and the electronic apparatus 2 are not limited to the configuration in FIG. 2, and various modified implementations such as omission of some of the elements thereof or addition of other elements thereto can be made.

The charging circuit 30 includes a first charging circuit 31 and a second charging circuit 32. The first charging circuit 31 is a circuit that performs constant-current charging. That is, the first charging circuit 31 performs constant-current charging in which the charging current ICH having a constant current value is supplied. Further, when the shutdown state of the battery 10 due to over-discharge is detected, the second charging circuit 32 first supplies the charging current ICH to charge the battery 10. By the second charging circuit 32 charging the battery 10 in such a manner, the shutdown state of the protection circuit 12 is released. Further, when the shutdown state of the protection circuit 12 is released in this way, the first charging circuit 31 increases the charging current from the initial current value to start the constant-current charging of the battery 10. That is, the first charging circuit 31 performs step-up current charging in which the charging current is increased from the initial current value larger than zero, and then performs the constant-current charging when the charging current reaches the target current value.

For example, in FIG. 2, the second charging circuit 32 includes a resistor RC and a switch SW for supplying a current for releasing the shutdown state of the protection circuit 12 to the battery 10. For example, the resistor RC and the switch SW are disposed in series between the node NIN at which the charging voltage VCH is supplied to the charging circuit 30 and the node NB at which the charging current ICH to the battery 10 is output. Then, when the shutdown state of the protection circuit 12 is detected, the switch SW is turned on. Accordingly, the charging current ICH flowing through the resistor RC is supplied to the battery 10 as a current for releasing the shutdown state of the protection circuit 12.

The voltage measurement circuit 40 measures the battery voltage VBAT. The battery voltage VBAT corresponds to, for example, the voltage VP of the positive terminal of the battery 10. For example, the voltage measurement circuit 40 measures the battery voltage VBAT of the node NB which is a charging node of the battery 10. For example, the voltage measurement circuit 40 performs analog-digital conversion of the battery voltage VBAT and outputs digital data of the battery voltage VBAT obtained by the analog-digital conversion to the control circuit 50.

Then, the control circuit 50 detects the release of the shutdown state of the protection circuit 12 based on the measurement result of the battery voltage VBAT by the voltage measurement circuit 40. For example, when the shutdown state of the protection circuit 12 is detected, the control circuit 50 first causes the second charging circuit 32 to charge the battery 10. Due to the charging by the second charging circuit 32, the protection circuit 12 releases the shutdown state in which the potential difference between the voltage VP and the voltage VM becomes 0 V. On this occasion, the control circuit 50 detects the release of the shutdown state based on the measurement result of the battery voltage VBAT by the voltage measurement circuit 40. For example, when the battery voltage VBAT rises due to the release of the shutdown state and reaches a predetermined detection voltage, the control circuit 50 determines that the shutdown state is released. Then, the control circuit 50 causes the first charging circuit 31 to increase the charging current from the initial current value larger than zero to start the constant-current charging of the battery 10.

The storage unit 60 stores various types of information, and is realized by a storage circuit such as a memory or a register. Further, the storage unit 60 stores an initial current value and a step-up current value in a step-up current described later in detail. Alternatively, the storage unit 60 may store an initial current value and a step-up time in the step-up current.

Further, in FIG. 2, the protection control circuit 13 includes a detection circuit 15 and a shutdown circuit 16. The detection circuit 15 detects the over-discharge state of the battery 10. Further, the detection circuit 15 can also detect an overcharge state of the battery 10.

For example, the detection circuit 15 includes a ladder resistor circuit disposed between a power supply voltage VDD at a high-potential side based on the voltage VP and the power supply voltage VSS at a low-potential side based on the voltage VM. The voltages VDD, VSS are used as power supply voltages of the protection circuit 12, for example. Further, the detection circuit 15 includes a comparator that compares the divisional voltage by the ladder resistor circuit with an over-discharge determination voltage, and detects the over-discharge state of the battery 10 based on the output result of the comparator. Further, the detection circuit 15 includes a comparator that compares the divisional voltage by the ladder resistor circuit with an overcharge determination voltage, and detects the overcharge state of the battery 10 based on the output result of the comparator. Note that a sense resistor (not shown) may be provided, and the detection circuit 15 may detect an overcurrent of the charging current or the discharging current.

The shutdown circuit 16 is implemented by a circuit that short-circuits a node of the voltage VP and a node of the voltage VM via a resistor when the protection circuit 12 is shut down, or the like. For example, the shutdown circuit 16 includes a resistor and a switch disposed in series between the node of the voltage VP and the node of the voltage VM. Further, when the switch is turned on during the shutdown of the protection circuit 12, the node of the voltage VP and the node of the voltage VM are short-circuited via the resistor. This results in the shutdown state in which the potential difference between the voltage VP and the voltage VM becomes 0 V.

FIG. 3 shows another detailed configuration example of the circuit device 20 and the electronic apparatus 2 according to the present embodiment. FIG. 3 is a configuration example when performing wireless charging in which the battery 10 is charged based on the power received with contactless power transmission. In FIG. 3, the circuit device 20 includes a power reception circuit 70 and a power feeding circuit 80 in addition to the charging circuit 30, the voltage measurement circuit 40, the control circuit 50, and the storage unit 60. Note that the circuit device 20 and the electronic apparatus 2 are not limited to the configuration in FIG. 3, and various modified implementations such as omission of some of the elements thereof or addition of other elements thereto can be made.

The power reception circuit 70 receives transmitted power from a power transmission device 14 in a contactless manner. That is, power is received wirelessly. For example, a primary coil L1 is disposed at a power transmission device 14 side, and a secondary coil L2 is disposed at a power reception device side including the circuit device 20. The power transmission device 14 is provided to, for example, a charging stand or a charging case that charges the electronic apparatus 2. Further, by a power transmission driver of the power transmission device 14 applying an AC voltage to the primary coil L1, the power is transmitted from the primary coil L1 to the secondary coil L2. The power reception circuit 70 receives the power from the power transmission device 14. Specifically, the power reception circuit 70 converts an AC induced voltage generated in the secondary coil L2 into a DC rectified voltage. This conversion is performed by a rectifier circuit 72 provided to the power reception circuit 70. The rectifier circuit 72 can be realized by, for example, a plurality of transistors or diodes. The charging circuit 30 charges the battery 10 based on the charging voltage VCH which is the rectified voltage.

The voltage measurement circuit 40 includes an analog-digital conversion circuit 42. The analog-digital conversion circuit 42 performs analog-digital conversion of the battery voltage VBAT of the node NB and outputs digital data obtained by the analog-digital conversion to the control circuit 50.

The storage unit 60 includes a register unit 62 and a nonvolatile memory 64. However, the storage unit 60 may be what is realized by one of the register unit 62 and the nonvolatile memory 64. For example, the nonvolatile memory 64 may be disposed outside the circuit device 20, and in this case, the storage unit 60 includes only the register unit 62.

The register unit 62 stores various types of information. The control circuit 50 reads information such as data and commands stored in the register unit 62, and operates. The register unit 62 can be realized by, for example, flip-flop circuits or a memory such as a RAM.

The nonvolatile memory 64 is a memory that can maintain stored content even when no power is supplied from the outside. The nonvolatile memory 64 can be realized by, for example, an electrically erasable programmable read-only memory (EEPROM) in which data can be erased, a one time programmable (OTP) memory using a floating gate avalanche injection MOS (FAMOS) or the like.

The register unit 62 stores various types of information by, for example, loading the information read from the nonvolatile memory 64. Alternatively, it is possible to arrange that an interface circuit (not illustrated) is provided to the circuit device 20, and the register unit 62 stores the information input from the outside via the interface circuit. Alternatively, it is possible to arrange that a communication circuit (not illustrated) that communicates with the power transmission device 14 is provided to the circuit device 20, and the register unit 62 stores the information received from the power transmission device 14 by the communication circuit.

The power feeding circuit 80 performs a discharging operation of the battery 10 to supply a power supply voltage based on the discharging operation to a power feeding target device 18. The power feeding target device 18 is, for example, a processing device such as a microcomputer provided to the electronic apparatus 2. Specifically, the power feeding circuit 80 operates using the battery voltage VBAT of the battery 10 as a power supply voltage. Then, the power feeding circuit 80 outputs the output voltage VOUT based on the battery voltage VBAT as the power supply voltage of the power feeding target device 18. For example, the power feeding circuit 80 includes a charge pump circuit, a switching regulator circuit, or the like, and the charge pump circuit or the switching regulator circuit performs a charge pump operation or a switching regulation operation of stepping down the battery voltage VBAT, and supplies the output voltage VOUT obtained by stepping down the battery voltage VBAT to the power feeding target device 18.

The circuit device 20 is provided with a charging-system circuit and a discharging-system circuit. The charging-system circuit operates based on the received power and charges the battery 10 as the charging target. For example, the charging-system circuit is supplied with the received power with the charging voltage VCH, and operates based on the charging voltage VCH to charge the battery 10. Meanwhile, the discharging-system circuit operates based on the battery voltage VBAT of the battery 10. That is, each circuit provided to the discharging-system circuit operates using the battery voltage VBAT as a power supply voltage. The power feeding circuit 80 provided as the discharging-system circuit outputs the output voltage VOUT based on the battery voltage VBAT as the power supply voltage of the power feeding target device 18.

Further, the register unit 62 is the discharging-system circuit. Further, a control circuit for the charging system and a control circuit for the discharging system are provided as the control circuit 50. The register unit 62 and the control circuit for the discharging system are arranged to be able to operate with the battery voltage VBAT as the power supply voltage even when no power is received by the power reception circuit 70.

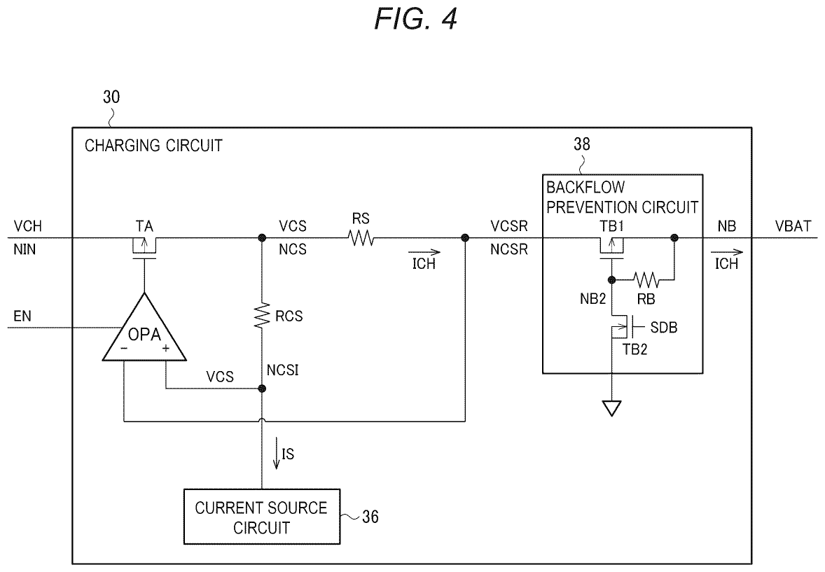

FIG. 4 shows a configuration example of the charging circuit 30. Note that FIG. 4 shows a configuration example of the first charging circuit 31 of FIG. 2. As shown in FIG. 4, the charging circuit 30 includes a current source circuit 36, an amplifier circuit OPA, a reverse current protection circuit 38, a transistor TA, and resistors RCS, RS. The amplifier circuit OPA can also be called an operational amplifier. Note that the charging circuit 30 is not limited to the configuration shown in FIG. 4, but it is possible to adopt a variety of modified implementations such as elimination of some of the elements or addition of other elements.

The current source circuit 36 outputs an output current IS based on a reference voltage. The output current IS is a current source current generated by a current source circuit 36. The output current IS is supplied to a non-inverting input terminal of the amplifier circuit OPA and a node NCS at a drain side of the P-type transistor TA. Then, based on the output current IS, the charging current ICH is generated by the amplifier circuit OPA, the transistor TA, and the resistors RS, RCS.

A source of the transistor TA is coupled to the node NIN, and a drain thereof is coupled to the node NCS. The node NIN is supplied with the charging voltage VCH. The resistor RCS is disposed between the node NCS and a node NCSI. The resistor RS is disposed between the node NCS and a node NCSR. In the amplifier circuit OPA, a non-inverting input terminal is coupled to the node NCSI, an inverting input terminal is coupled to the node NCSR, and an output terminal is coupled to a gate of the transistor TA. An operation of the amplifier circuit OPA is enabled when an enable signal EN is at a low level. Accordingly, the charging current ICH (=(RCS/RS)×IS) is supplied to the node NCSR, and is supplied as the charging current ICH to the node NB which is the charging node.

The reverse current protection circuit 38 includes a P-type transistor TB1, an N-type transistor TB2, and a resistor RB. In the transistor TB1, a source is coupled to the node NB and a drain is coupled to the node NCSR. In the N-type transistor TB2, a source is coupled to a ground node and a drain is coupled to a node NB2 of a gate of the transistor TB1. The resistor RB is disposed between the node NB and the node NB2.

When starting charging the battery 10, the control circuit 50 turns on the transistor TB2 with a control signal SDB. Accordingly, the transistor TB1 is also turned on, the charging current ICH flows from the node NCSR to the node NB, and the battery 10 is charged. When ending charging the battery 10, the control circuit 50 turns off the transistor TB2 with the control signal SDB. Accordingly, the transistor TB1 is also turned off, and the reverse current protection circuit 38 prevents the reverse current of a charge from the battery 10 to the charging circuit 30.

### 2. Initial Current Value of Step-Up Current

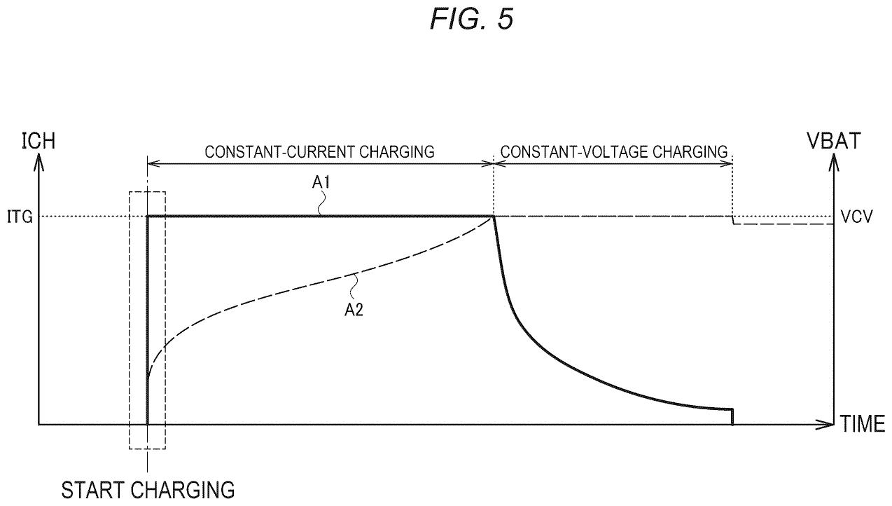

FIG. 5 is a diagram illustrating CCCV charging. In FIG. 5, A1 represents a change in the charging current ICH in the CCCV charging, and A2 represents a change in the charging voltage VCH. In the CCCV charging, when charging is started, first, constant-current charging with the target current value ITG is performed. Then, when the battery voltage VBAT reaches a predetermined voltage, the constant-current charging is switched to the constant-voltage charging to charge the battery 10.

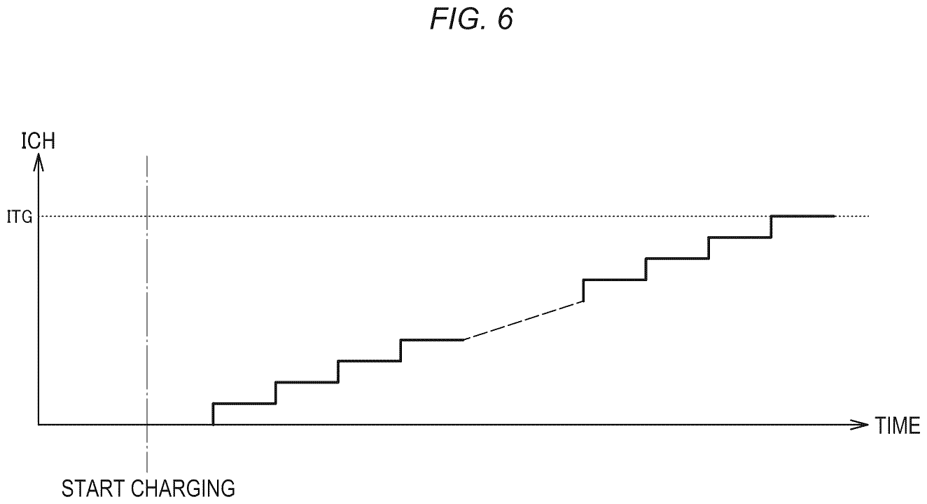

In this case, there is a step-up current method in which the charging current is increased in a step-up manner as shown in FIG. 6 without setting the charging current to the target current value ITG immediately at the start of charging as shown in FIG. 5. For example, in FIG. 6, the charging current is increased in a step-up manner from the initial current value of zero, and when the charging current reaches the target current value ITG, the constant-current charging with the target current value ITG is performed.

In the present embodiment, the initial current value in such a step-up current is variably set. Specifically, the initial current value is set to a value larger than zero. Further, the step-up current value or the step-up time in the step-up current may be variably set.

For example, in the case of charging using wireless power feeding shown in FIG. 3, the received power PW that can be used for charging is expressed by a relational expression of PW=VCH×(ICH+IOP)−VBAT×ICH from the charging voltage VCH, the battery voltage VBAT, the charging current ICH, and a consumption current IOP. In this case, when the charging current ICH is rapidly increased from zero to the target current value ITG as shown in FIG. 5 by the charging circuit 30 capable of controlling the charging current in a multi-bit resolution, the charging voltage VCH drops. Therefore, as shown in FIG. 6, the step-up current charging in which the charging current ICH is gradually increased to the target current value ITG in a step-up manner is performed. On this occasion, at the same time, the transmission power is gradually increased by the power transmission device 14 shown in FIG. 3 so that VCH does not drop using power control.

Further, as illustrated in FIGS. 1 to 3, the protection circuit 12 called PCM is attached to the battery 10 such as a secondary battery, and when the protection circuit 12 is in a discharge prohibition state and the shutdown state, the battery voltage VBAT viewed from the circuit device 20 that is a charging device is 0 V. This is because, in the shutdown state, the protection control circuit 13 short-circuits the node of the voltage VP and the node of the voltage VM via the resistor so that the potential difference between the voltage VP and the voltage VM becomes 0 V.

On this occasion, the first charging circuit 31 in FIG. 2, which can control the charging current in a multi-bit resolution, cannot cause the charging current to flow. Therefore, the shutdown state of the protection circuit 12 is released by charging with the second charging circuit 32 which causes the charging current to flow via the resistor RC disposed between the node NIN of VCH and the node NB of VBAT. When the shutdown state is released, the battery voltage VBAT of the battery 10 becomes visible from the circuit device 20, and the constant-current charging in which the first charging circuit 31 capable of controlling the charging current in the multi-bit resolution causes the charging current to flow is performed.

However, it has been found out that when step-up current charging is performed starting from the initial current value of zero (0 A) as shown in FIG. 6 after the shutdown state of the protection circuit 12 is released, there is a problem that the protection circuit 12 returns to the shutdown state again due to the initial current value of zero at the first step-up.

In addition, step-up current charging may be performed not only in the wireless charging shown in FIG. 3 but also in the contact-type charging in some cases. For example, by stepping up the charging current in a stepwise manner, the internal resistance of the battery 10 can be estimated from a change in the current and a change in the battery voltage. Therefore, the step-up current is also used in the contact-type charging. However, in this case, when the step-up time is long, it takes a long time to reach the target current value. For example, in general, the contact-type charging can cause a larger charging current to flow than the charging by wireless power feeding, and can shorten the charging time. However, when the target current value is large, there is a problem that the time until the target current value is reached by the step-up current suppresses the charging speed.

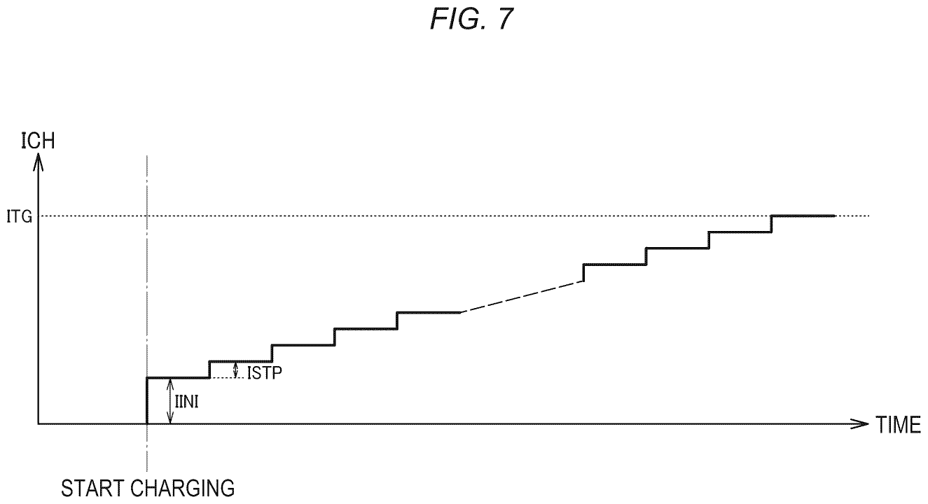

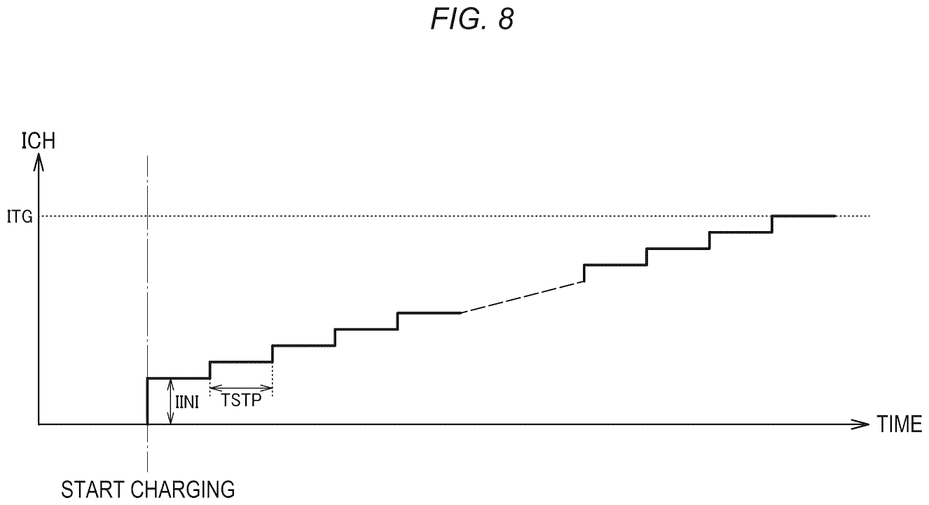

Therefore, in the present embodiment, as shown in FIG. 7, it is arranged that an initial current value IINI of the step-up current can be set to any values. Alternatively, it is arranged that a step-up current value ISTP of the step-up current can be set to any values. Alternatively, it is also possible to arrange that as shown in FIG. 8, a step-up time TSTP of the step-up current can be set to any values. The step-up current value ISTP is a current difference value between a second current value and a first current value when the charging current ICH is increased stepwise from the first current value to the second current value in a step-up manner, and is an increment of the second current value with respect to the first current value. That is, the charging current ICH is increased stepwise by the step-up current value ISTP. The step-up time TSTP is a time difference between the second timing and the first timing when the charging current ICH having the first current value flows at the first timing and the charging current ICH having the second current value flows at the second timing. That is, the charging current ICH is increased stepwise every step-up time TSTP.

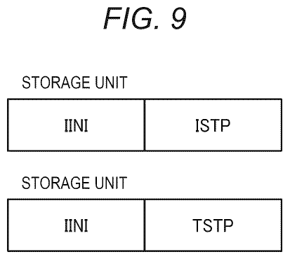

FIG. 9 is a diagram illustrating storage of the initial current value IINI of the step-up current and so on into the storage unit 60. For example, the initial current value IINI and the step-up current value ISTP of the step-up current described in FIG. 7 are stored in the storage unit 60. Alternatively, the initial current value IINI and the step-up time TSTP of the step-up current described in FIG. 8 are stored in the storage unit 60. The initial current value IINI and the step-up current value ISTP or the step-up time TSTP are stored in, for example, the nonvolatile memory 64, and are loaded from the nonvolatile memory 64 into the register unit 62 when the circuit device 20 operates. Further, the control circuit 50 controls the charging circuit 30 based on the initial current value IINI and the step-up current value ISTP or the step-up time TSTP loaded into the register unit 62. Then, the charging circuit 30 performs the step-up current charging shown in FIG. 7 based on the initial current value IINI and the step-up current value ISTP. Alternatively, the charging circuit 30 performs step-up current charging shown in FIG. 8 based on the initial current value IINI and the step-up time TSTP.

Further, in the present embodiment, when the shutdown state of the protection circuit 12 is released, the control circuit 50 causes the charging circuit 30 to increase the charging current from an initial current value larger than zero to start the constant-current charging of the battery 10. For example, as illustrated in FIGS. 7 and 8, when the shutdown state is released, the charging circuit 30 increases the charging current ICH in a step-up manner from the initial current value IINI larger than zero, and starts the constant-current charging when the charging current ICH reaches the target current value ITG. In this way, it is possible to prevent the initial current value IINI of zero from flowing to make the protection circuit 12 return to the shutdown state again when the shutdown state of the protection circuit 12 is released. Then, it becomes possible to increase the charging current ICH from the initial current value IINI larger than zero to start the constant-current charging of the battery 10.

For example, when the battery voltage is lower than the voltage for over-discharge determination detected by the protection circuit 12, the protection circuit 12 comes into the shutdown state and sets the potential difference between the voltage VP and the voltage VM to 0 V. When the circuit device 20 as the charging device recognizes that the potential difference between the voltage VP and the voltage VM is 0 V after the charging voltage is applied, the circuit device 20 releases the shutdown state of the protection circuit 12 by performing the charging with the second charging circuit 32 in FIG. 2.

When the shutdown state is released in this way, (the battery voltage)+VF becomes to be detected between the voltage VP and the voltage VM. That is, when the shutdown state is released and the short circuit between the node of the voltage VP and the node of the voltage VM by the shutdown circuit 16 of the protection control circuit 13 is released, the voltage obtained by adding the forward voltage VF caused by the charging current from the second charging circuit 32 flowing through the diode DI1 to the battery voltage becomes to be seen from the circuit device 20 side. This enables charging by the first charging circuit 31.

Further, it has been found out that the protection circuit 12 returns to the shutdown state again when there is a period in which the charging current does not flow when the charging by the second charging circuit 32 is switched to the charging by the first charging circuit 31. That is, when the initial current value in the step-up current is zero as shown in FIG. 6, the zero charging current continues until the charging current increases from zero (0 A) by the first step-up, and the protection circuit 12 returns to the shutdown state again.

Further, there is a problem that when the initial current value of the step-up current is zero, a series of processing of detecting the shutdown state, releasing the shutdown state by charging with the second charging circuit 32, and increasing the charging current from the initial current value of zero by the first charging circuit 31 is repeated as long as the battery voltage is lower than the voltage for the over-discharge determination.

In this regard, in the present embodiment, since the charging current is increased from the initial current value larger than zero when the shutdown state is released, it is possible to prevent the problem described above from occurring. Then, the charging current is increased from the initial current value larger than zero, and when the charging current reaches the target current value, it becomes possible to appropriately charge the battery 10 by starting the constant-current charging.

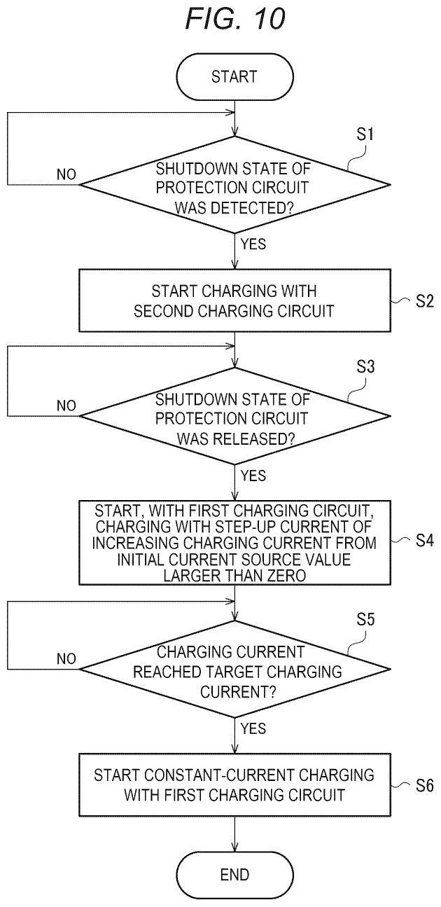

FIG. 10 is a flowchart illustrating operations of the present embodiment. First, it is determined whether the shutdown state of the protection circuit 12 is detected (step S1). For example, since the potential difference between the voltage VP and the voltage VM becomes 0 V when the protection circuit 12 comes into the shutdown state, the circuit device 20 detects the potential difference between the voltage VP and the voltage VM to determine whether the protection circuit 12 is in the shutdown state. Then, when the shutdown state is detected, charging with the second charging circuit 32 is started (step S2). For example, the second charging circuit 32 in FIG. 2 performs charging in which a charging current based on the voltage difference between VCH and VBAT flows via the resistor RC. Then, whether the shutdown state of the protection circuit 12 is released is determined (step S3). For example, the release of the shutdown state is detected by the voltage measurement circuit 40 measuring the battery voltage VBAT. Then, when the release of the shutdown state is detected, the first charging circuit 31 starts charging with the step current of increasing the charging current from the initial current value larger than zero (step S4). That is, as shown in FIGS. 7 and 8, the charging current is increased in a step-up manner from the initial current value IINI larger than zero. Then, whether the charging current has reached the target current value ITG is determined, and when the charging current has reached the target current value ITG, the constant-current charging by the first charging circuit 31 is started (steps S5, S6).

As described above, the circuit device 20 according to the present embodiment includes the charging circuit 30 that charges the battery 10 and the control circuit 50 that controls the charging circuit 30 as illustrated in FIGS. 1 to 3. Further, the battery 10 is provided with the protection circuit 12 that comes into the shutdown state when the battery 10 is in the over-discharge state. For example, the battery 10 and the protection circuit 12 are housed in the battery pack. Further, when the shutdown state of the protection circuit 12 is released, the control circuit 50 causes the charging circuit 30 to increase the charging current from an initial current value larger than zero to start the constant-current charging of the battery 10. For example, as shown in FIGS. 7 and 8, the charging current is increased in the step-up manner from the initial current value larger than zero, and when the charging current reaches the target current value, the constant-current charging is started.

In this way, since the charging circuit 30 supplies the charging current having the initial current value larger than zero to the battery 10 when the shutdown state of the protection circuit 12 is released, it is possible to prevent a period in which the charging current does not flow to the battery 10 after the shutdown state is released from occurring. Therefore, it is possible to prevent the protection circuit 12 from returning to the shutdown state again due to the occurrence of a period in which no current flows after the shutdown state is released. As a result, it is possible to appropriately execute the charging control of increasing the charging current from the initial current value to perform the constant-current charging after the shutdown state is released.

Further, as shown in FIG. 2, the charging circuit 30 includes the first charging circuit 31 that performs constant-current charging and the second charging circuit 32. Further, when the shutdown state of the protection circuit 12 is detected, the control circuit 50 causes the second charging circuit 32 to charge the battery 10. That is, charging by the second charging circuit 32 is first performed instead of immediately performing charging by the first charging circuit 31 capable of constant-current charging. Then, when the shutdown state of the protection circuit 12 is released, the constant-current charging of the battery 10 is started with the first charging circuit 31 increasing the charging current from the initial current value larger than zero.

In this way, it becomes possible to release the shutdown state of the protection circuit 12 by the charging with the second charging circuit 32 when the protection circuit 12 is in the shutdown state. Then, it becomes possible for the first charging circuit 31 to increase the charging current from the initial current value larger than zero to perform the constant-current charging after the shutdown state is released.

Further, as shown in FIG. 2, the second charging circuit 32 includes the resistor RC and the switch SW for supplying the current for releasing the shutdown state to the battery 10.

In this way, it becomes possible for the second charging circuit 32 to supply the current flowing through the resistor RC to the battery 10 when the protection circuit 12 is in the shutdown state. Further, by supplying the current flowing through the resistor RC, it becomes possible to release the shutdown state of the protection circuit 12.

Further, as illustrated in FIG. 2, the resistor RC and the switch SW of the second charging circuit 32 are disposed in series between the node NIN at which the charging voltage VCH is supplied to the charging circuit 30 and a node NB at which the charging current ICH to the battery 10 is output. Further, the switch SW is turned on when the shutdown state is detected.

In this way, when the shutdown state is detected, the switch SW is turned on, so that the current corresponding to the voltage difference between the charging voltage VCH and the battery voltage VBAT becomes to flow through the resistor RC coupled in series to the switch SW. Further, it becomes possible to release the shutdown state of the protection circuit 12 by supplying the current via the resistor RC to the battery 10.

Further, as shown in FIGS. 2 and 3, the circuit device 20 includes the storage unit 60 that stores the initial current value. That is, as shown in FIG. 9, the storage unit 60 stores the initial current value IINI of the step-up current. The initial current value IINI is a current value of the charging current output first in the step-up current.

In this way, it becomes possible to read the initial current value IINI larger than zero from the storage unit 60, increase the charging current from the initial current value IINI, and start the constant-current charging of the battery 10. For example, it becomes possible to increase the charging current from the initial current value IINI, and then start the constant-current charging when the charging current reaches the target current value.

Further, as illustrated in FIG. 7, the control circuit 50 increases the charging current to the battery 10 by the charging circuit 30 from the initial current value IINI with the step-up current value ISTP to set the charging current to the target current value ITG, to thereby cause the charging circuit 30 to perform the constant-current charging with the target current value ITG.

In this way, it is possible to increase the charging current from the initial current value IINI by the step-up current value ISTP after supplying the charging current of the initial current value IINI larger than zero to the battery 10. Then, when the charging current reaches the target current value ITG, it becomes possible to supply the constant charging current having the target current value ITG to the battery 10. In this case, it becomes possible to adjust the time until the target current value ITG is reached by changing the magnitude of the step-up current value ISTP. For example, when the target current value ITG is large, the time until the target current value ITG is reached can be shortened by increasing the step-up current value ISTP. For example, in the contact-type charging described above, even when the target current value ITG of the constant-current charging is large, it becomes possible to shorten the time until the target current value ITG is reached by increasing the step-up current value ISTP.

Further, as shown in FIGS. 2 and 3, the circuit device 20 includes the storage unit 60 that stores the step-up current value ISTP. That is, as shown in FIG. 9, the storage unit 60 stores the step-up current value ISTP of the step-up current. The step-up current value ISTP is an increment of the current when increasing the charging current stepwise in the step-up current.

In this way, it becomes possible to read the step-up current value ISTP from the storage unit 60, increase the charging current stepwise by the step-up current value ISTP, and then start the constant-current charging of the battery 10. For example, it becomes possible to increase the charging current by the step-up current value ISTP, and then start the constant-current charging when the charging current reaches the target current value ITG.

Further, as illustrated in FIG. 8, the control circuit 50 increases the charging current to the battery 10 by the charging circuit 30 from the initial current value IINI every step-up time TSTP to set the charging current to the target current value ITG, to thereby cause the charging circuit 30 to perform the constant-current charging with the target current value ITG.

In this way, it is possible to increase the charging current from the initial current value IINI every step-up time TSTP after supplying the charging current of the initial current value IINI larger than zero to the battery 10. Then, when the charging current reaches the target current value ITG, it becomes possible to supply the constant charging current having the target current value ITG to the battery 10. In this case, it becomes possible to adjust the time until the target current value ITG is reached by changing the length of the step-up time TSTP. For example, when the target current value ITG is large, it becomes possible to shorten the time until the target current value is reached by reducing the step-up time TSTP, and it becomes also possible to cope with the contact-type charging in which the target current value ITG is large.

Further, as shown in FIGS. 2 and 3, the circuit device 20 includes the storage unit 60 that stores the step-up time TSTP. That is, as shown in FIG. 9, the storage unit 60 stores the step-up time TSTP of the step-up current. The step-up time TSTP is a time interval when the charging current is increased stepwise in the step-up current.

In this way, it becomes possible to read the step-up time TSTP from the storage unit 60, increase the charging current stepwise every step-up time TSTP, and then start the constant-current charging of the battery 10. For example, it becomes possible to increase the charging current every step-up time TSTP, and then start the constant-current charging when the charging current reaches the target current value ITG.

Further, as illustrated in FIGS. 2 and 3, the circuit device 20 includes the voltage measurement circuit 40 that measures the battery voltage VBAT of the battery 10. For example, the voltage measurement circuit 40 performs the analog-digital conversion of the battery voltage VBAT and outputs measurement result data to the control circuit 50. Then, the control circuit 50 detects the release of the shutdown state of the protection circuit 12 based on the measurement result of the battery voltage VBAT by the voltage measurement circuit 40.

In this way, it becomes possible for the control circuit 50 to determine whether the shutdown state of the protection circuit 12 is released by the voltage measurement circuit 40 measuring the battery voltage VBAT and outputting the measurement result to the control circuit 50 when the shutdown state of the protection circuit 12 is released. Further, it becomes possible for the control circuit 50 to make the charging circuit 30 increase the charging current from the initial current value larger than zero and start the constant-current charging of the battery 10 when the control circuit 50 detects that the shutdown state of the protection circuit 12 is released based on the measurement result of the voltage measurement circuit 40.

Further, as shown in FIG. 3, the circuit device 20 includes the power reception circuit 70 that receives power supplied from the power transmission device 14 by contactless power transmission. Further, the charging circuit 30 charges the battery 10 based on the received power received by the power reception circuit 70.

In this way, it becomes possible to charge the battery 10 with the charging circuit 30 based on the power received in a contactless manner by the power reception circuit 70 from the power transmission device 14. Further, when the battery 10 is charged with the power received in a contactless manner in this way, when it is attempted to immediately charge the battery 10 with a large charging current, a problem such as a drop in the charging voltage VCH used by the charging circuit 30 occurs. In this regard, in the present embodiment, since the battery 10 can be charged with the charging current increased from the initial current value, it becomes possible to prevent the problem described above when immediately charging the battery 10 with the large charging current from occurring.

As described above, a circuit device according to the present embodiment includes a charging circuit configured to charge a battery and a control circuit configured to control the charging circuit. Further, the battery is provided with a battery protection circuit that comes into a shutdown state when the battery is in an over-discharge state. Further, when the shutdown state of the protection circuit is released, the control circuit causes the charging circuit to increase the charging current from an initial current value larger than zero to start constant-current charging of the battery.

In this way, since the charging current is increased from the initial current value larger than zero when the shutdown state of the protection circuit is released, it is possible to prevent a situation in which the protection circuit returns to the shutdown state again due to an occurrence of a period in which the charging current does not flow to the battery after the shutdown state is released. Accordingly, even when the protection circuit that comes into the shutdown state when the battery is in the over-discharge state is used, it becomes possible to realize appropriate constant-current charging of the battery.

Further, in the present embodiment, the charging circuit may include a first charging circuit that performs constant-current charging and a second charging circuit. Further, the control circuit may cause the second charging circuit to charge the battery when the shutdown state is detected, and may cause the first charging circuit to increase the charging current from the initial current value to start the constant-current charging of the battery when the shutdown state is released.

In this way, it becomes possible to release the shutdown state of the protection circuit by charging with the second charging circuit when the protection circuit is in the shutdown state, and increase the charging current from the initial current value to perform the constant-current charging with the first charging circuit after releasing the shutdown state.

Further, in the present embodiment, the second charging circuit may include a resistor and a switch configured to supply a current for releasing the shutdown state to the battery.

With this configuration, it becomes possible to supply a current flowing through the resistor to the battery with the second charging circuit to release the shutdown state of the protection circuit when the protection circuit is in the shutdown state.

Further, in the present embodiment, the resistor and the switch may be disposed in series between a node at which a charging voltage is supplied to the charging circuit and a node from which a charging current to the battery is output, and the switch may be turned on when the shutdown state is detected.

In this way, it becomes possible to cause a current corresponding to a voltage difference between the charging voltage and the battery voltage to flow through the resistor coupled in series to the switch that is turned on, to release the shutdown state of the protection circuit.

Further, in the present embodiment, a storage unit configured to store an initial current value may be provided.

In this way, it becomes possible to increase the charging current from the initial current value read from the storage unit to start the constant-current charging.

Further, in the present embodiment, the control circuit may increase the charging current by the charging circuit to the battery from the initial current value by the step-up current value and set the charging current to the target current value to thereby cause the charging circuit to perform the constant-current charging with the target current value.

In this way, it becomes possible to increase the charging current from the initial current value to the target current value by a step-up current value to start the constant-current charging.

Further, in the present embodiment, a storage unit configured to store the step-up current value may be provided.

In this way, it becomes possible to increase the charging current by the step-up current value read from the storage unit to start the constant-current charging.

Further, in the present embodiment, the control circuit may increase the charging current by the charging circuit to the battery from the initial current value every step-up time and set the charging current to the target current value to thereby cause the charging circuit to perform the constant-current charging with the target current value.

In this way, it becomes possible to increase the charging current from the initial current value every step-up time to start the constant-current charging.

Further, in the present embodiment, a storage unit configured to store the step-up time may be provided.

In this way, it becomes possible to increase the charging current stepwise every step-up time read from the storage unit to start the constant-current charging.

Further, in the present embodiment, a power reception circuit configured to receive power supplied from the power transmission device by contactless power transmission may be provided, and the charging circuit may charge the battery based on the power received by the power reception circuit.

In this way, it becomes possible to charge the battery with the charging circuit based on the power in a contactless manner received by the power reception circuit from the power transmission device. Further, it becomes possible to prevent a problem that occurs when the battery is immediately charged with a large charging current since the battery can be charged by increasing the charging current from the initial current value.

Further, an electronic apparatus according to the present embodiment includes the circuit device described above, a battery, and a protection circuit.

Note that although the present embodiment is described in detail above, those skilled in the art should easily understand that many modifications can be made without substantially departing from the novel matters and the advantages of the present disclosure. Accordingly, all such modifications should be within the scope of the present disclosure. For example, a term described at least once in the specification or the drawings along with a different term broader or the same in meaning can be replaced with that different term anywhere in the specification and the drawings. Further, all combinations of the present embodiment and the modifications are also included in the scope of the present disclosure. Further, the configurations, operations, and so on of the circuit device, the electronic apparatus, and the protection circuit are not limited to those described in the present embodiment, and various modifications can be made thereon.

What is claimed is:

1. A circuit device comprising:
a charging circuit configured to charge a battery; and
a control circuit configured to control the charging circuit, wherein
the battery is provided with a protection circuit of the battery that comes into a shutdown state when the battery is in an over-discharge state, and
the control circuit causes the charging circuit to increase a charging current from an initial current value larger than zero to start constant-current charging of the battery when the shutdown state of the protection circuit is released.

2. The circuit device according to claim 1, wherein
the charging circuit includes
a first charging circuit configured to perform the constant-current charging and
a second charging circuit, and
the control circuit
causes the second charging circuit to charge the battery when the shutdown state is detected, and
causes the first charging circuit to increase the charging current from the initial current value to start the constant-current charging of the battery when the shutdown state is released.

3. The circuit device according to claim 2, wherein
the second charging circuit includes a resistor and a switch configured to supply a current for releasing the shutdown state to the battery.

4. The circuit device according to claim 3, wherein
the resistor and the switch are disposed in series between a node at which a charging voltage is supplied to the charging circuit and a node at which the charging current to the battery is output, and
the switch is turned on when the shutdown state is detected.

5. The circuit device according to claim 1, further comprising
a storage unit configured to store the initial current value.

6. The circuit device according to claim 1, wherein
the control circuit increases the charging current to the battery by the charging circuit from the initial current value by a step-up current value to set the charging current to a target current value to thereby cause the charging circuit to perform the constant-current charging with the target current value.

7. The circuit device according to claim 6, further comprising
a storage unit configured to store the step-up current value.

8. The circuit device according to claim 1, wherein
the control circuit increases the charging current to the battery by the charging circuit from the initial current value every step-up time to set the charging current to a target current value to thereby cause the charging circuit to perform the constant-current charging with the target current value.

9. The circuit device according to claim 8, further comprising
a storage unit configured to store the step-up time.

10. The circuit device according to claim 1, further comprising
a voltage measurement circuit configured to measure a battery voltage of the battery, wherein
the control circuit detects release of the shutdown state based on a measurement result of the battery voltage by the voltage measurement circuit.

11. The circuit device according to claim 1, further comprising
a power reception circuit configured to receive power supplied from a power transmission device by contactless power transmission, wherein
the charging circuit charges the battery based on the power received by the power reception circuit.

12. An electronic apparatus comprising:
the circuit device according to claim 1;
the battery; and
the protection circuit.
